(19) United States
(12) Patent Application Publication
(10) Pub. No.: US 2025/0371444 A1
(43) Pub. Date: Dec. 4, 2025

(54) FIELD WORKFORCE DISPATCHING WITH INTEGER PROGRAMMING

(71) Applicant: International Business Machines Corporation, Armonk, NY (US)

(72) Inventors: Dung Tien Phan, Pleasantville, NY (US); Ali Koc, White Plains, NY (US); Pavankumar Murali, Ardsley, NY (US); Pavithra Harsha, Pleasantville, NY (US); Stephane Michel, Roquefort les Pins (FR); Yuan Yuan Jia, BeiJing (CN); James Thomas Rayfield, Ridgefield, CT (US); Roman Vaculin, Larchmont, NY (US)

(21) Appl. No.: 18/732,720

(22) Filed: Jun. 4, 2024

(51) Int. Cl. G06Q 10/04; G06Q 10/0631

(52) U.S. Cl. CPC G06Q 10/04; G06Q 10/06311

(57) ABSTRACT

A computer-implemented method of generating a directed graph associated with a set of workers, a set of customers, and a set of tasks associated with the set of customers, based on: customer information associated with the set of tasks; and resource and budget information associated with the set of customers is provided. Aspects include generating an extended knowledge graph based on the directed graph and a set of operation and business rules. Aspects include generating, based on the extended knowledge graph, a mixed-integer linear program (MILP) problem associated with completing the set of tasks. Aspects include generating, by a MILP solver engine, one or more solutions associated with dispatching and managing the set of workers in association with solving the MILP problem.

### STATEMENT REGARDING PRIOR DISCLOSURES BY THE INVENTOR OR A JOINT INVENTOR

The following disclosure(s) are submitted under 35 U.S.C. 102(b)(1)(A):

“Mathematical Programming for Field Workforce Dispatching,” Phan, D. et al., IBM Research, 2023.

### BACKGROUND

The present disclosure generally relates to field service management, and more particularly, field workforce management and dispatching with integer programming.

Field workforce management may include dispatching personnel (e.g., technicians, workers) to locations (e.g., off-site locations) for completing tasks such as, for example, equipment installation, maintenance, or asset repair under operational and budget constraints. In some cases, effective workforce management may be negatively impacted due to factors related to available personnel, tasks to be completed, constraints or rules associated with the tasks, and target response times for completing the tasks.

### SUMMARY

Embodiments of the present disclosure are directed to a computer-implemented method including: generating a directed graph associated with a set of workers, a set of customers, and a set of tasks associated with the set of customers, based on: customer information associated with the set of tasks; and resource and budget information associated with the set of customers; generating an extended knowledge graph based on the directed graph and a set of operation and business rules, wherein the set of operation and business rules are associated with the set of workers, the set of customers, the set of tasks, and one or more facilities associated with the set of tasks; generating, based on the extended knowledge graph, a mixed-integer linear program (MILP) problem associated with completing the set of tasks; and generating, by an MILP solver engine, one or more solutions associated with dispatching and managing the set of workers in association with solving the MILP problem.

Embodiments of the present disclosure are directed to a computing system having a memory having computer readable instructions and one or more processors for executing the computer readable instructions, the computer readable instructions controlling the one or more processors to perform operations including: generating a directed graph associated with a set of workers, a set of customers, and a set of tasks associated with the set of customers, based on: customer information associated with the set of tasks; and resource and budget information associated with the set of customers; generating an extended knowledge graph based on the directed graph and a set of operation and business rules, wherein the set of operation and business rules are associated with the set of workers, the set of customers, the set of tasks, and one or more facilities associated with the set of tasks; generating, based on the extended knowledge graph, a mixed-integer linear program (MILP) problem associated with completing the set of tasks; and generating, by an MILP solver engine, one or more solutions associated with dispatching and managing the set of workers in association with solving the MILP problem.

Embodiments of the present disclosure are directed to a computer program product including a computer readable storage medium having program instructions embodied therewith, the program instructions executable by a processor to cause the processor to perform operations including: generating a directed graph associated with a set of workers, a set of customers, and a set of tasks associated with the set of customers, based on: customer information associated with the set of tasks; and resource and budget information associated with the set of customers; generating an extended knowledge graph based on the directed graph and a set of operation and business rules, wherein the set of operation and business rules are associated with the set of workers, the set of customers, the set of tasks, and one or more facilities associated with the set of tasks; generating, based on the extended knowledge graph, a mixed-integer linear program (MILP) problem associated with completing the set of tasks; and generating, by an MILP solver engine, one or more solutions associated with dispatching and managing the set of workers in association with solving the MILP problem.

Other embodiments of the present invention implement features of the above-described method in computer systems and computer program products.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings.

FIG. 1 illustrates a block diagram of an example computer system for use in conjunction with one or more embodiments of the present disclosure.

FIG. 2 illustrates a block diagram of an example computing system that supports field workforce management and dispatching in accordance with one or more embodiments of the present disclosure.

FIG. 3 illustrates a block diagram representing an example field workforce management and dispatching problem in accordance with one or more embodiments of the present disclosure.

FIG. 4 illustrates an example flowchart of a method that supports field workforce management and dispatching in accordance with one or more embodiments of the present disclosure.

FIG. 5 illustrates a table of example capabilities which an MILP solver described herein may consider in association with generating a solution for field workforce management and dispatching in accordance with one or more embodiments of the present disclosure.

FIG. 6 illustrates an example flowchart of a method that supports field workforce management and dispatching in accordance with one or more embodiments of the present disclosure.

### DETAILED DESCRIPTION

Systems and techniques are described herein supportive of field workforce management and dispatching. The systems and techniques described herein support determining an optimal set of routes for a fleet of personnel (e.g., crews, vehicles, and the like) to serve a given set of customers, each with specific demands, while minimizing the total cost. The systems and techniques support features capable of effectively modeling real-world constraints common to real-life enterprises (e.g., modeling of real-life constraints). Non-limiting examples of the constraints include multiple time windows (e.g., time availabilities, operating hours, or the like), multiple depots (e.g., distribution centers) with heterogeneous vehicles, multiple commodities/crafts, synchronized visits, personnel availability (e.g., crew open shifts), and the like.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as field workforce management and dispatching using a management engine 150. In addition to management engine 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and management engine 150, as identified above), peripheral device set 114 (including user interface (UI), device set 123, storage 124, and Internet of Things (IoT) sensor set 135), and network module 115. Remote server 104 includes remote database 132. Public Cloud 105 includes gateway 130, Cloud orchestration module 131, host physical machine set 142, virtual machine set 143, and container set 144.

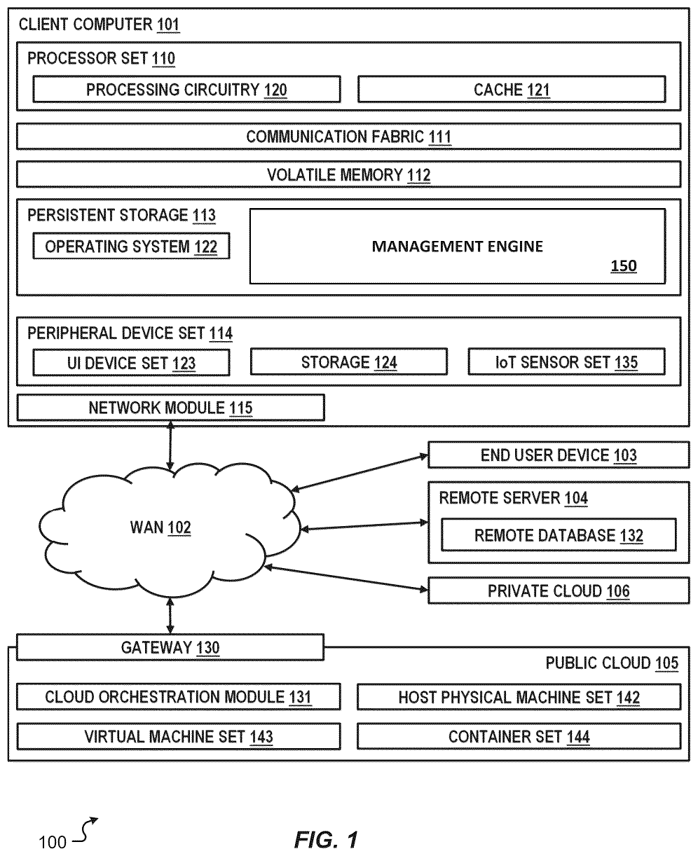

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in management engine 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in management engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

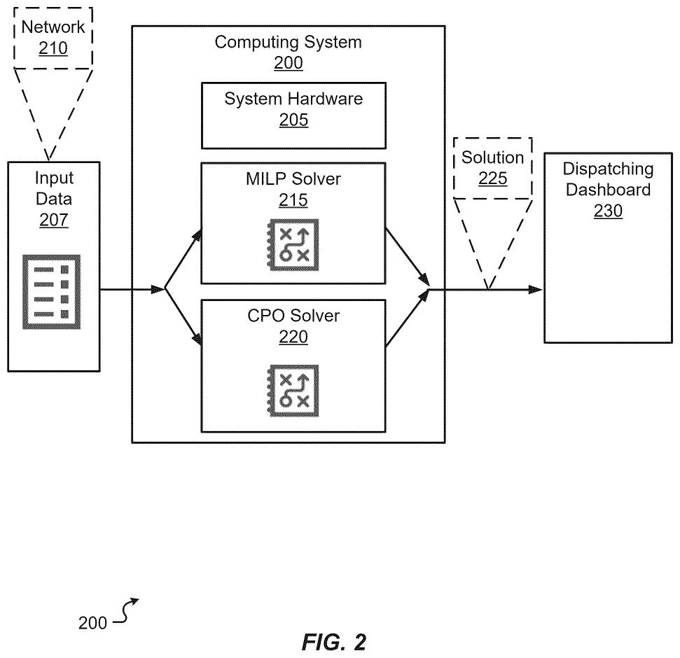

FIG. 2 illustrates a block diagram of an example computing system 200 that supports field workforce management and dispatching in accordance with one or more embodiments of the present disclosure.

All or a portion of the system 200 shown in FIG. 2 can be implemented, for example, by all or a subset of the computing environment 100 of FIG. 1. In one or more embodiments, the computing system 200 is embodied in a computer 101 as the one shown in FIG. 1. In one or more embodiments, the computing system 200 is embodied in an end user device 103 as the one shown in FIG. 1.

The computing system 200 supports optimization for large-scale dispatching in a suitable application suite including applications for asset monitoring, management, predictive maintenance and reliability planning. For example, the computing system 200 supports performing enterprise field service management operations capable of optimizing schedules, resources, and asset performance while delivering sustainable outcomes. The computing system 200 supports field workforce management for planning, scheduling, dispatching, and tracking work tasks.

The computing system 200 includes system hardware 205. The system hardware 205 includes the central processing units (CPUs), graphical processing units (GPUs), memory, and the like that are part of the computing system. The system hardware 205 executes computer code stored at a memory (e.g., volatile memory 112, persistent storage 113, storage 124, and the like described with reference to FIG. 1) of the computing system 200.

The computing system 200 supports mixed integer linear programming (MILP) solving and constraint programming optimization (CPO). The computing system 200 includes a MILP solver 215 (also referred to herein as an MILP optimizer or an MILP optimization engine) and a solver 220 (also referred to herein as a CPO solver or a CPO engine).

The MILP solver 215 supports features for lower bound and optimality gap measurements. The MILP solver 215 may perform and solve optimality proofs in association with field workforce management and dispatching described herein.

The MILP solver 215 leverages mathematical programming for solving many resource allocation problems (e.g., field workforce management and dispatching) described herein. The MILP solver 215 supports a MILP based math-programming model capable of handling various practical business constraints and objective functions as yet another model along with the solver 220.

The MILP solver 215 may provide a globally optimal solution for MILP, improving KPIs and productivity compared to constraint programming. Non-limiting examples of KPIs improved by the MILP solver 215 in a solution 225 for a field workforce management and dispatching problem include quantity of vehicles, transition hours, routing, quantity of crew members, and the like. In some aspects, the MILP solver 215 may support features for providing a gap to the optimal value at early termination, providing opportunity awareness for improvement. As described herein, the MILP solver 215 supports features for accounting for complicated business rules and uncertainty awareness, and accordingly, providing improved decisions in the solution 225 compared to other approaches. Aspects of the MILP solver 215 are capable of overcoming challenges associated with field workforce management and dispatching problems of increased sophistication. For example, aspects of the MILP solver 215 support solving NP-hard problems, which are a class of problems in computer science known for their inherent difficulty. The term “NP” denotes nondeterministic polynomial time, signifying problems that lack efficient solutions or are known as challenging to solve. For example, NP-hard problems may involve a significant amount of computational resources to solve according to some other approaches, and aspects of the MILP solver 215 support effective solving of NP-hard problems including a reduction in computational resources, reduced processing time, increased processing efficiency, and higher accuracy.

Aspects of the MILP solver 215 described herein leverage increased computational performance of MILP solvers, as the computational performance has increased at an astonishing rate (e.g., 1000×) due to progress in hardware and algorithms. In accordance with one or more embodiments of the present disclosure, the computing system 200 and MILP solver 215 are capable of solving large dispatching datasets (e.g., 1000s of technicians with 10k work orders) and, in some cases, in view of some business rules not available in some spatial models.

The solver 220 supports features for solving scheduling and similar problems. The solver 220 supports features for constraint-based identification of high-quality solutions according to increased speeds.

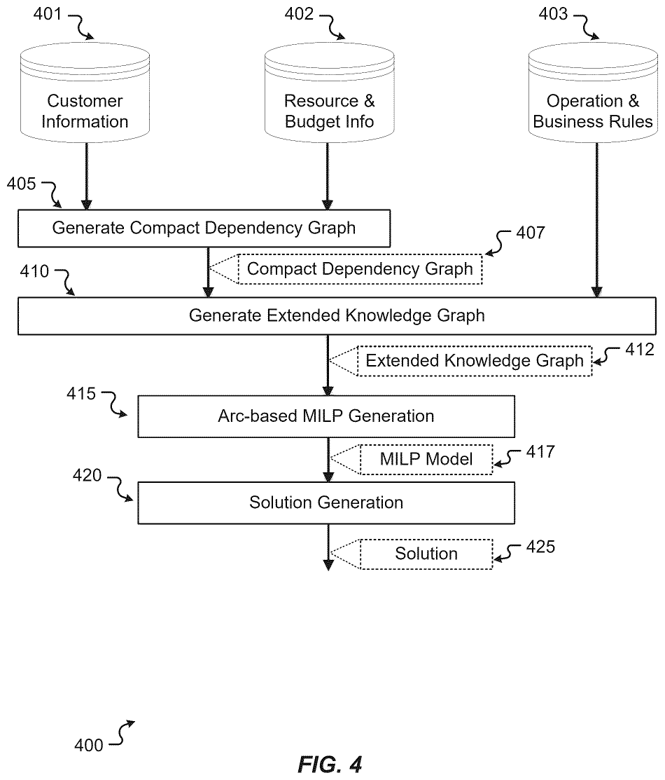

In accordance with one or more embodiments of the present disclosure, the MILP solver 215 may provide a solution 225 (e.g., a guaranteed solution) based on processing the input data 207. The input data 207 may be representative of a network 210 including a set of crews (or crew members), a set of customers, a set of tasks, a set of depots, and a set of routes which interconnect the crews (or crew members), customers, tasks, and depots, example aspects of which are later described herein. In some examples, the input data 207 may include customer information 401, resource and budget information 402, and operation and business rules 403 later described herein with reference to FIG. 4.

In some aspects, as later described herein, the MILP solver 215 may obtain an initial solution from the solver 220 within a limited running time (e.g., a predetermined amount of time, a relatively short amount of time), and the MILP solver 215 may use the initial solution from the solver 220 as a start point for MILP solving techniques described herein. Accordingly, for example, using the MILP solver 215, the computing system 200 may provide the solution 225 (guaranteed solution) based on processing the input data 207 and data (the initial solution) from the solver 220. That is, the computing system 200 may generate the solution 225 by initiating and running the MILP solver 215 and the solver 220.

The solution provided by the MILP solver 215 may differ from some other field workforce management and dispatching solutions, for example, in that the output provided by the MILP solver 215 is a guaranteed solution rather than a heuristic solution (e.g., a solution by trial and error or by rules that are loosely defined). Additional example aspects of the MILP solver 215 and solver 220 will later described herein.

As will be described herein, the systems and techniques described herein provide improved scheduling and earlier task completion compared to some other approaches (e.g., using a solver 220 alone). In some aspects, the computing system 200 is capable of generating output data indicating how far a present solution (e.g., solution 225) is from an optimal solution for solving a field workforce management and dispatching problem provided in the input data 207. Aspects of the field workforce management and dispatching supported by the computing system 200 support operations for tuning based on defined parameters (e.g., obtaining a prediction or solution 225 in 10 seconds or less in exchange for reduced optimization, obtaining a prediction or solution 225 having higher accuracy in exchange for increased processing time, or the like). In some aspects, the computing system 200 may support setting one or more time parameters (e.g., a processing time limit) for obtaining a solution 225.

The field workforce management and dispatching supported by the computing system 200 may include dispatching of work to crews and labor problem specification. In some examples, the input data 207 may include a list of available technicians (e.g., 1000s of technicians), available jobs (e.g., 10k jobs, tasks, or the like), and constraints or rules associated with the jobs and/or available technicians. The computing system 200 may support effectively implementing field workforce management and dispatching within a target response time (e.g., a relatively fast response time compared to some other approaches). Non-limiting examples of crews and labor problems include airlines for crew dispatching, manufacturing (e.g., Airbus), energy and utilities, and the like.

As will be described herein, aspects of the computing system 200 provide various advantages compared to some other approaches. For example, the computing system 200 supports using mathematical programming (e.g., at the MILP solver 215) with algebraic functions to model one or more problems for field workforce management and dispatching. The MILP solver 215 may support both discrete variables (e.g., a target time of 7 am) and continuous decision variables (e.g., a numerical representation such as, for example, 7.0). The MILP solver 215 may support lower bounds and be capable of providing optimality gap measure. The MILP solver 215 may be capable of providing optimality proofs associated with provided solutions 225.

The MILP solver 215 provides increased flexibility for modeling operational and business constraints such as, for example, balancing work/drive time over technicians, minimizing changes to an existing routing plan, or the like. The MILP solver 215 is capable of robust scheduling considering uncertainty on travel and work time.

In contrast, for example, some other approaches which rely on constraint programming alone with logical inferences may be fast to find a feasible solution but be restricted to discrete problems. For example, such other approaches may be unable to model operational and business constraints (e.g., balance work/drive time over technicians, minimizing change to an existing routing plan) which the MILP solver 215 is capable of modeling.

The computing system 200 may be integrated with or be electrically coupled to a user interface implemented by device set 123 of FIG. 1. The computing system 200 may provide (e.g., visually, audibly, and the like) a dispatching dashboard 230 via the user interface, based on the solution 225. The computing system 200 may display, via the user interface, the dispatching dashboard 230.

Example aspects of the computing system 200 in association with field workforce management and dispatching are further described with reference to the following figures and Equations.

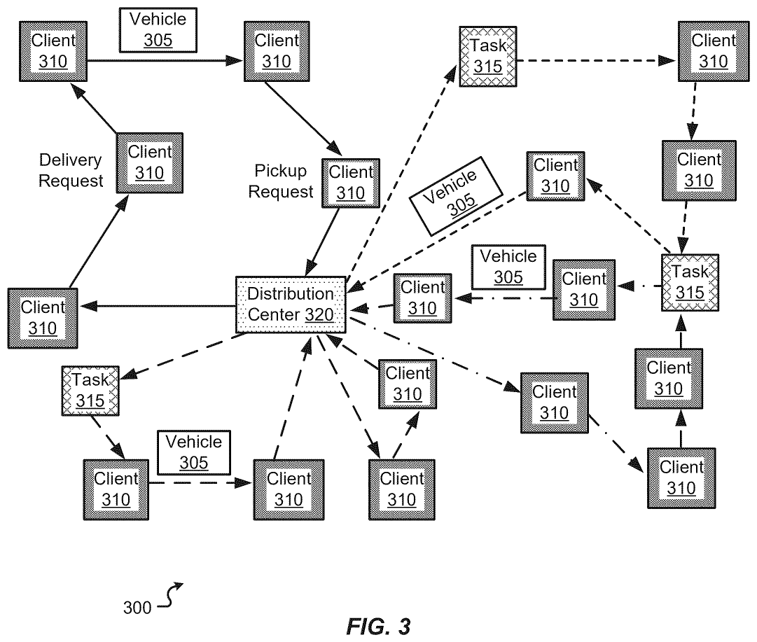

FIG. 3 illustrates a block diagram 300 representing an example field workforce management and dispatching problem in accordance with one or more embodiments of the present disclosure.

Referring to FIG. 3, the computing system 200 supports determining an optimal set of routes for a fleet of personnel (e.g., crews, vehicles 305, and the like) to serve a given set of customers (e.g., clients 310), each with specific demands, while minimizing the total cost. The systems and techniques support features capable of effectively modeling real-world constraints common to real-life enterprises (e.g., modeling of real-life constraints). Non-limiting examples of the constraints include multiple time windows (e.g., time availabilities, operating hours, or the like with respect to a given client 310), multiple depots (e.g., distribution centers 320) with heterogeneous vehicles 305, multiple commodities/crafts, synchronized visits, personnel availability (e.g., crew open shifts associated with a crew member and/or a vehicle 305), and the like.

In an example implementation, the computing system 200 (e.g., using MILP solver 215) may generate a solution 225 according to target parameters such as, for example, maximizing the quantity of clients 310 serviced or serviceable by the fleet of personnel, minimizing the quantity of vehicles 305, utilizing the shortest paths and/or shortest travel times, and the like. In an example, the computing system 200 may treat the problem illustrated at FIG. 3 as a general vehicle routing problem. An example of generating the solution 225 is described with reference to FIG. 4.

FIG. 4 illustrates an example flowchart of a method 400 that supports field workforce management and dispatching in accordance with one or more embodiments of the present disclosure. The method 400 may be implemented by the example aspects of a computing environment 100 or a computing system 200 as described herein. An example of the method 400 is now described with reference to computing system 200 and block diagram 300.

The method 400 supports assigning a fleet of crews (or crew members) (e.g., vehicles 305) to serve a given set of customers (e.g., clients 310), each with specific demands, while minimizing the total cost with the optimal set of routes for each crew (or crew member).

At 405, the method 400 includes generating a compact dependency graph 407 based on customer information 401 (also referred to herein as customer data) and resource and budget information 402. In some aspects, the compact dependency graph 407 may include a consideration of side constraints described herein accounting for unacceptable moves in the graph (e.g., precedence constraints, technician-task matching, not allowed to travel between depots, not enough time to travel between tasks). The compact dependency graph 407 may also be referred to herein as a dependency graph, a knowledge graph, or a compact knowledge graph.

The compact dependency graph 407 may include nodes representative of variables associated with the field workforce management and dispatch problem. Non-limiting examples of the variables include crews (e.g., vehicles 305), customers (e.g., clients 310), jobs (e.g., tasks 315), depots (e.g., distribution centers 320, facilities), and routes. In an example, the compact dependency graph 407 may be a directed graph representative of a network including a set of crews (or crew members), a set of customers, a set of tasks, a set of depots, and routes which interconnect the crews (or crew members), customers, tasks, and depots. The compact dependency graph 407 may be absent self-loops. The compact dependency graph 407 may include nodes and edges corresponding to a network of crews (or crew members), customers, tasks, depots, and routes.

In an example, the customer information 401 may include, for a given node of the compact dependency graph 407, a target skill requirement for a crew member and a target duration for completing a task. In an example, the resource and budget information 402 may include a priority ordering associated with attending to nodes of the compact dependency graph 407. For example, the resource and budget information 402 may include an indication that a “Node A” should be visited and/or serviced by a crew member before a “Node B.”

At 410, the method 400 includes generating an extended knowledge graph 412 (also referred to herein as an extended dependency graph) based on the compact dependency graph and operation and business rules 403. In an example, the method 400 may include forming the extended knowledge graph 412 by using the operation and business rules 403 for handling multi-window problems (e.g., multiple temporal periods), multi-day problems, and multi-depot problems, and removing invalid moves (e.g., moves associated with precedence constraints later described herein).

In some aspects, the operation and business rules 403 may include temporal parameters associated with each customer (e.g., each client 310), each task (e.g., each task 315), each depot (e.g., each distribution center 320, each facility), and the like. In an example, the operation and business rules 403 may include, for each customer (e.g., each client 310), the earliest time that a crew member can visit the customer's site, the latest time that a crew member can visit the customer's site, days on which no crew member is allowed at the customer's site, and the like. In another example, the operation and business rules 403 may include, for each crew (e.g., each vehicle 305), constraints associated with when the crew is to be deployed (e.g., start of day), when the crew is to return (e.g., at end of day), and the like.

At 415, the method 400 includes arc-based MILP generation. In an example, at 415, the method 400 includes constructing a MILP model 417 using the extended dependency graph and the operation and business rules 403 (e.g., operational/resource constraints). The MILP model 417 is capable of optimization operations associated with crew scheduling. For example, the MILP model 417 is capable of keeping track of the movement of a crew or crew member(s) to a first task (e.g., movement of a vehicle 305 to a task 315), and further, movement of the crew or the crew member(s) between tasks (e.g., movement of the vehicle 305 to another task 315) by two separate types of 2-dimensional decision vectors. Accordingly, for example, the method 400 includes tracking movement of one or more workers to a first task, tracking movement of the one or more workers between the first task and at least one other task, or both based on the extended knowledge graph 412.

In an example, at 415, the method 400 includes formulating a set of constraints and objectives by a set of linear equations. In some aspects, the method 400 may include incorporating the constraints, objectives, and linear equations into the MILP model 417. The use of linear equations as described herein supports effective solving of field workforce management and dispatching problems. For example, some other workforce management and dispatch solutions may incorporate the use of non-linear equations, which may result in a high amount of overhead (e.g., processing time) and, in some cases, a failure to provide a solution (e.g., a field workforce management and dispatch solution) due to the complexity associated with using non-linear equations.

At 420, the method 400 includes generating a solution 425 using the constructed MILP model. The solution 425 may be a field workforce management and dispatch solution described herein. In some examples, the method 400 may include obtaining an initial solution from a constraining programming optimizer (e.g., solver 220) within a limited running time, and the method 400 may include using the initial solution as a start point for the MILP model in association with generating the solution 425.

Non-limiting examples of the customer information 401, resource and budget information 402, operation and business rules 403, compact dependency graph 407, extended knowledge graph 412, generation of the MILP model 417, and generation of a solution 425 in association with the method 400 are later described herein.

Aspects of mathematical programming for field workforce dispatching are described in Phan, D. et al., “Mathematical Programming for Field Workforce Dispatching,” IBM Research, 2023, which is incorporated herein by reference in its entirety for all purposes. Aspects of mathematical programming for field workforce dispatching in accordance with one or more embodiments of the present disclosure are described herein with reference to the following examples, tables, and equations.

### Determining a Dependency Graph (e.g., Compact Dependency Graph 407)

The systems and techniques described herein introduce a mixed-integer linear program (MILP) for solving the dispatching problem. The systems and techniques described herein consider a network (N,A) including a set of technicians W and set of tasks T as a directed graph without self-loops, where N=W∪T is the set of nodes and A ⊆N×N is the set of directed arcs. Denote Nᵢⁱⁿ by the set of in-neighbors of node i (i.e., Nᵢⁱⁿ={j∈N|(j,i)∈A}). Denote Nᵢ^{out} by the set of out-neighbors of node i (i.e., Nᵢ^{out}={j ∈N|(i,j)∈A}). The assignment of the n-th technician (n∈W) to each task i located at node i∈T is characterized by two parameters: start time tᵢ and service duration sⁿᵢ. The binary variable xⁿᵢⱼ takes value 1 if the n-th technician performs task i, and then performs job j by traveling on arc (i,j). xⁿₙⱼ=1 (j∈T) means that the first task the n-th technician performs is j. Travel time from node i to node j is d_{i,j}. The systems and techniques described herein assume that each technician n begins his/her shift at the start location and returns to the end location or finish the last task no later than the time horizon T. The schedule time is assumed to start at time 0 for the planning horizon T, and the scheduling problem is for D days.

To make a MILP scalable, the systems and techniques described herein utilize a formulation with the least number of variables, especially binary variables, and the least number of constraints. To do so, pre-processing is a crucial step to reduce the size of the problem. The systems and techniques described herein suggest the following.

Note that the set of directed arcs A needs to be pre-processed to account for unacceptable moves in the graph such as precedence constraints (i.e., dependency between visits), technician style-task matching, not allowed to travel between depots, no self-loops, enough time to travel between tasks (i.e., removing (i,j) such that bᵢ+min_{n∈Wi}(sⁿᵢ)+dᵢⱼ>min_{n∈Wj}(^{s}jⁿ)+eⱼ). The systems and techniques described herein assume that if there are technician precedence constraints for a task, it is divided into multiple tasks.

The systems and techniques described herein assume that majority of technicians have the same lunch break time, for example 12 pm-1 pm. By pre-processing and post-processing, the systems and techniques described herein can use the assumption that the time horizon is contiguous by shifting, i.e., [8 am-12 pm] U [1 pm-5 pm]′[0,8], where [8 am-12 pm]′[0,4], [1 pm-5 pm]′[4-8]. In some aspects, the systems and techniques described herein only need to introduce additional variables for technician with ad-hoc shifts, that is, when the technician has an irregular shift start/end time

$$[ {p}_{u}^{n} , {q}_{u}^{n} ]$$

and/or a different break type (not 12-1 pm). The systems and techniques described herein also concatenate the end (i.e., 5 pm) and beginning of days (i.e., 8 am). By using the convention, T=D×working time of day; for example, with time unit is hour and working time of day=8 hours, then T=8×D.

### Determining an Extended Dependency Graph (e.g., Extended Knowledge Graph 412) for Multi-Day and Multi-Depot

To track the location of a technician for the end of a working day over D days, in an example case, the techniques described herein define an artificial set of tasks

$${𝒯}_{W}^{d}$$

the end of each day d, which reserves a location for the technician as the end location for each day. Each task in

$${𝒯}_{W}^{d}$$

is uniquely related to a technician.

The example assumes that the service time for any task in T_{W}^{d} is zero (i.e., sⁿᵢ=0 if i^{∈T}_{W}^{d}), the travel time dᵢⱼ between any i^{∈T}_{W}^{d1} and j^{∈T}_{W}^{d2} is zero with i=j and d₂>d₁. There is no arc between technician locations, that is, if

$$i ∈ {𝒯}_{W}^{{d}_{1}} , j ∈ {𝒯}_{W}^{{d}_{2}} , {d}_{2} \leq {d}_{1} or i ∈ {𝒯}_{W}^{{d}_{1}} , j ∈ {𝒯}_{W}^{{d}_{2}} , {d}_{1} < {d}_{2} , i \neq j .$$

Assume the site open hours for every

$$i ∈ {𝒯}_{W}^{d}$$

is [d*T_{day}, T] for any d=0, 1, . . . , D (where

$${𝒯}_{W}^{0} {=}^{Δ} 𝒲 ) .$$

The techniques described herein include partitioning the (actual) task set into interruptible tasks (denoted by Tᵢₙₜ) and uninterruptible tasks (denoted by Tᵤₙ). By a slight abuse of notation, the example case now uses

$$𝒯 = {𝒯}_{int} ⋃ {𝒯}_{un} ⋃ {𝒯}_{W}^{1} ⋃ … ⋃ {𝒯}_{W}^{D - 1}$$

and N=W ∪T∪T_{W}^{D}.

In the data model, travel time is used to include travel time between depots and tasks. If travel time between a depot and a task is not considered, the example case includes assigning dᵢⱼ=0 for every i∈W∪T_{W}¹ ∪ . . . ∪T_{W}^{D-1} or j∈T_{W}¹∪ . . . ∪T_{W}^{D}.

For interruptible tasks on several days, the systems and techniques described herein handle the case for interrupting due to the end of the day but not completed, and assume that for the next day, the same technicians will perform the task at the beginning of the day (e.g., resume at 8 am for an 8 am-5 pm working day). Mathematically, the systems and techniques described herein may be implemented without adding constraints to model a technician going back to the end location and then coming to the on-going task from the start location. The systems and techniques described herein consider this case by adding a cost of type dᵢₙ+dₙᵢ.

TABLE 1
Notation for the MILP model

Indices

| | |
|---|---|
| i, j, | tasks |
| n, | technician |
| t, | technician type |
| l, | level of a technician and 1 is the most proficient |

Sets

| | |
|---|---|
| [symbol] , | tasks that need to be addressed |
| [symbol] ^{blg}, | backlog tasks with the high priority (first in time) |
| [symbol] ^{int}, | work orders that can be interrupted |
| [symbol] , | set of technicians |
| [symbol] , | set of types of technicians (i.e., ‘craft’) |
| [symbol] , | set of levels of technicians |
| [symbol] ⁱ, | eligible set of technicians in the work zone who can address some aspects of task i |
| ${𝒲}_{sync}^{i} ,$ | set of synchronized tasks for task i |
| [symbol] , | = [symbol] ∪ [symbol] |
| [symbol] , | feasible arcs in the location graph of work orders and technicians, |
| | (i, j) ∈ [symbol] for some i ∈ [symbol] = [symbol] ∪ [symbol] and j ∈ [symbol] |
| ${𝒩}_{i}^{in} ,$ | the set of in-neighbors of node i |
| ${𝒩}_{i}^{out} ,$ | the set of out-neighbors of node i |

Parameters

| | |
|---|---|
| D, | number of scheduling days |
| T, | [0, T] scheduling horizon |
| T_{day}, | during of a working day, e.g. T_{day} = 8(hours) |
| bᵢ, | earliest start time of task i |
| eᵢ, | latest end time of task i |
| ${s}_{i}^{n} ,$ | service time of task i ∈ [symbol] for technician n, assume |
| rᵢ, | number of technicians of type t of minimum skill level l needed for task i |
| dᵢⱼ, | driving time between task or technician i ∈ [symbol] ∪ [symbol] to task or technician j ∈ [symbol] ∪ [symbol] |
| gᵢ, | value of completing task i - combine service time duration, priority |
| M, | max_{(i,j)∈A}(eᵢ − dᵢⱼ) |
| ${c}_{1}^{n} ,$ | cost associated with technician n to perform task i |
| ${p}_{u}^{n} ,$ | start of available times for technician n for u = 1, . . . , Iⁿ |
| ${q}_{u}^{n} ,$ | end of available times for technician n for u = 1, . . . , Iⁿ |
| Iⁿ | the number of open time slots for technician n, uₘₐₓ = maxₙIⁿ |
| bₒᵢ, | start of available times for task i for o = 1, . . . , ${T}_{open}^{i}$ |
| eₒᵢ, | end of available times for task i for o = 1, . . . , ${T}_{open}^{i}$ |
| ${T}_{open}^{i} ,$ | the number of open time slots for task i, ${o}_{max} = {max}_{i} {T}_{open}^{i}$ |

Decision Variables

| | |
|---|---|
| tᵢ, | $( ∈ {ℝ}_{+}^{\vert 𝒩 \vert} , i ∈ 𝒩 ) global start time of task i ∈ 𝒯 across technicians ,$ |
| | assume tᵢ = 0 for i ∈ [symbol] or task i is unperformed. |
| ${x}_{ij}^{n} ,$ | (∈ {0, 1}^{\|} [symbol] ^{\|/\|} [symbol] ^{\|}) binary variable if technician n performs task i ∈ [symbol] before |
| | performing task j ∈ [symbol] or returning to her/his depot (generated for n ∈ [symbol] ⁱ ∩ [symbol] ^{j}, (i, j) ∈ [symbol] .) |
| | $Note that i ∈ 𝒲 ⋃ 𝒯 , j ∈ 𝒯 ⋃ {𝒯}_{W}^{D} ∀ ( i , j ) ∈ 𝒜$ |
| ${z}_{i}^{n} ,$ | $( ∈ {ℝ}_{+}^{\vert 𝒲 \vert \times \vert 𝒯 \vert} ) auxiliary variable if task i is assigned to technician n , generated for n ∈ {𝒲}^{i} , i ∈ 𝒯$ |
| $\text{?}$ | (∈ {0, 1} n ∈ [symbol] , u ∈ 1, . . ., uₘₐₓ) if technician n is deployed at the u-th shift time slot for task i |
| ${ξ}_{oi}^{n} ,$ | (∈ {0, 1}, n ∈ [symbol] , o ∈ 1, . . ., oₘₐₓ) if technician n is deployed at the o-th open time for task i |
| ${ξ}_{oi}^{n} ,$ | (∈ {0, 1}, n ∈ [symbol] , d ∈ l, . . ., D) if technician n is deployed at the d-th day for task i |
| ${t}_{over}^{n} ,$ | $( ∈ {ℝ}_{+}^{\vert 𝒲 \vert} , n ∈ 𝒲 )$ delay in technician n reaching depot beyond [symbol] or completing the last task. |

[symbol]

indicates data missing or illegible when filed

### Three-Index Formulation

For simplicity of exposition, the systems and techniques described herein introduce an auxiliary variable

$${z}_{i}^{n} ∈ \{ 0 , 1 \}$$

to model if task i is assigned to technician n, generated for n∈Wⁱ,i∈T.

$${z}_{i}^{n} = \begin{matrix}{\sum }_{j ∈ {𝒩}_{i}^{out}} {x}_{ij}^{n} , & ∀ i ∈ 𝒯 , n ∈ {𝒲}^{i} .\end{matrix} \qquad ( 1 )$$

### Detailed Explanations for Constraints:

The n-th technician can be deployed from the start location for at most one task.

$$\begin{matrix}{\sum }_{j ∈ {𝒩}_{n}^{out}} {x}_{nj}^{n} \leq 1 , & ∀ n ∈ 𝒲\end{matrix} \qquad ( 2 )$$

Each node i∈T satisfies the technician flow balance constraint for every n-th technician.

$$\begin{matrix}{\sum }_{j ∈ {𝒩}_{i}^{out}} {x}_{ij}^{n} = {\sum }_{i ∈ {𝒩}_{i}^{in}} {x}_{ij}^{n} , & ∀ n ∈ 𝒲 , i ∈ 𝒯\end{matrix} \qquad ( 3 )$$

For technician n and tasks i,j, the previous service time s″; plus driving time dᵢⱼ is less than the next start time tⱼ. The systems and techniques described herein also consider i∈W, which supports tracking the first job for a technician, i.e., if

$${x}_{nj}^{n} = 1 .$$

$$\begin{matrix}{t}_{i} + {s}_{i}^{n} + {d}_{ij} - {t}_{j} \leq ( 1 - {x}_{ij}^{n} ) M , & ∀ n ∈ {𝒲}^{i} ⋂ {𝒲}^{i} , ( i , j ) ∈ 𝒜\end{matrix} \qquad ( 4 )$$

Here, note that A is defined where i∈N, j∈T. So, arcs from task to depot is not specified here.

Earliest start time and latest end time of task i (assume Tₒₚₑₙⁱ=1).

$${b}_{i} \frac{{\sum }_{n ∈ {𝒲}^{i}} {z}_{i}^{n}}{{r}_{i}} \leq {t}_{i} \begin{matrix}, & ∀ i ∈ 𝒯\end{matrix} \qquad ( 5 )$$

$${t}_{i} + {z}_{i}^{n} {s}_{i}^{n} \leq {e}_{i} \begin{matrix}\frac{{\sum }_{n ∈ {𝒲}^{i}} {z}_{i}^{n}}{{r}_{i}} , & ∀ i ∈ 𝒯\end{matrix} \qquad ( 6 )$$

Visit site open hours (multiple time windows, assume of Tₒₚₑₙⁱ>1): Assume that task i is un-interruptible, it is completely executed in a site open hour [bₒᵢ, eₒᵢ] for some o ∈{1, . . . , Tₒₚₑₙⁱ}.

$$\begin{matrix}{z}_{i}^{n} = {\sum }_{o = 1}^{{T}_{open}^{i}} {ξ}_{oi}^{n} & ∀ i ∈ 𝒯 , n ∈ {𝒲}^{i} , ( n , i ) ∈ 𝒜\end{matrix} \qquad ( 7 )$$

$$\begin{matrix}{\sum }_{o} {b}_{io} {ξ}_{oi}^{n} \leq {t}_{i} , & ∀ i ∈ 𝒯 , n ∈ {𝒲}^{i} , ( n , i ) ∈ 𝒜\end{matrix} \qquad ( 8 )$$

$$\begin{matrix}{t}_{i} + {z}_{i}^{n} {s}_{i}^{n} \leq {e}_{oi} + ( 1 - \sum {ξ}_{oi}^{n} ) {M}_{ni}^{task} , & ∀ i ∈ 𝒯 , n ∈ {𝒲}^{i} , ( n , i ) ∈ 𝒜\end{matrix} \qquad ( 9 )$$

Multi-day constraints: As mentioned earlier, the systems and techniques described herein may consider uninterruptible tasks without considering interruptible tasks (e.g., only need to consider uninterruptible tasks), and force a condition for a technician to return the end location at the end of day. The systems and techniques described herein treat this case similar to the case “visit site open hours” for uninterruptible tasks, where ξ_{di}ⁿ places the same role as ξₒᵢⁿ. Consider i∈Tᵤₙ:

$$\begin{matrix}{z}_{i}^{n} = {\sum }_{d = 1}^{D} {ξ}_{oi}^{n} & ∀ i ∈ 𝒯 , n ∈ {𝒲}^{i} , ( n , i ) ∈ 𝒜\end{matrix} \qquad ( 10 )$$

$$\begin{matrix}( d - 1 ) {T}_{day} {ξ}_{di}^{n} \leq {t}_{i} , & ∀ i ∈ 𝒯 , n ∈ {𝒲}^{i} , ( n , i ) ∈ 𝒜 , d ∈ \{ 1 , … , D \}\end{matrix} \qquad ( 11 )$$

$$\begin{matrix}{t}_{i} + {ξ}_{di}^{n} ( {s}_{i}^{n} + {d}_{io} ) \leq d * {T}_{day} + ( 1 - {ξ}_{oi}^{n} ) {M}_{ni}^{untask} , & ∀ i ∈ 𝒯 , n ∈ {𝒲}^{i} , ( n , i ) ∈ 𝒜 , d ∈ \{ 1 , … , D \}\end{matrix} \qquad ( 12 )$$

If no driving time to the end location is considered, (12) is replaced by (13).

$$\begin{matrix}{t}_{i} + {ξ}_{di}^{n} {s}_{i}^{n} \leq d * {T}_{day} + ( 1 - {ξ}_{di}^{n} ) {M}_{ni}^{untask} , & ∀ i ∈ 𝒯 , n ∈ {𝒲}^{i} , ( n , i ) ∈ 𝒜 , d ∈ \{ 1 , … , D \}\end{matrix} \qquad ( 13 )$$

Return to the end location n before the end of the scheduling horizon (option 2a).

$$\begin{matrix}{t}_{j} + {s}_{j}^{n} + {d}_{jn} \leq T + {t}_{over}^{n} + {M}_{1} ( 1 - {z}_{j}^{n} ) , & ∀ n ∈ 𝒲 , j ∈ 𝒯\end{matrix} \qquad ( 14 )$$

Enough time to finish the last task before the end of the scheduling horizon (option 2b).

$$\begin{matrix}{t}_{j} + {s}_{j}^{n} \leq T + {t}_{over}^{n} + {M}_{1} ( 1 - {z}_{j}^{n} ) , & ∀ n ∈ 𝒲 , j ∈ 𝒯\end{matrix} \qquad ( 15 )$$

### Synchronized Visits:

Several synchronized tasks (starting at the same time) each requesting a craft (may be different crafts and possibly each task with a different duration):

$$\begin{matrix}{r}_{j} {\sum }_{n ∈ {𝒲}^{i}} {z}_{i}^{n} = {r}_{i} {\sum }_{n ∈ {𝒲}^{j}} {z}_{j}^{n} , & ∀ i ∈ 𝒯 , j ∈ {𝒲}_{sync}^{i}\end{matrix} \qquad ( 16 )$$

$$\begin{matrix}\frac{{\sum }_{n ∈ {𝒲}^{i}} {z}_{i}^{n}}{{r}_{i}} - 1 \leq {t}_{i} - {t}_{j} \leq 1 - \frac{{\sum }_{n ∈ {𝒲}^{i}} {z}_{j}^{n}}{{r}_{j}} , & ∀ i ∈ 𝒯 , j ∈ {𝒲}_{sync}^{i}\end{matrix} \qquad ( 17 )$$

Here the systems and techniques described herein may be implemented under an assumption that tasks i and j are synchronized then they have to be performed at the same time or both unperformed. The systems and techniques described herein support constraining the number of resources needed for the task.
Case 1: If task i is scheduled to be executed, task's required resources for certain quantity

$${r}_{i}^{t , l}$$

and level t,l in some time period is as follows. The systems and techniques described herein use logical constraints.

$$\begin{matrix}if {\sum }_{n ∈ {𝒲}^{i}} {z}_{i}^{n} \geq 1 \to {\sum }_{n ∈ {𝒲}^{i}} {z}_{i}^{n} = {r}_{i} & ∀ i ∈ 𝒯 , t ∈ 𝒮 , l ∈ ℒ\end{matrix} \qquad ( 18 )$$

Note that zᵢⁿ needs to declare a binary variable if using discrete constraints.
Case 2: At most one technician performs the task.

$$\begin{matrix}{\sum }_{n ∈ {𝒲}^{i}} {z}_{i}^{n} \leq 1 , & ∀ n ∈ {𝒲}^{i} , i ∈ 𝒯 .\end{matrix} \qquad ( 19 )$$

Technician shift open hours or slots: A technician starts from home and ends at home. In optimization, the formulation depends on the option for including travel time in total time and constraints. (=1: default checked in spatial optimization scenario, travel time=travel from home+travel between tasks in shift+travel home, =0: travel time=travel between tasks in shift).
Case 1: Assume that task i is un-interruptible, it is completely executed in a shift open hours

$$[ {p}_{\text{?}}^{n} , {q}_{\text{?}}^{n} ]$$

$$\text{?} \text{indicates text missing or illegible when filed}$$

for some u. “un-interrupupie” means that the technician only allows to take a lunch break. In some aspects, the systems and techniques described herein enforce these following equations for technician n with shift open hours, then for relevant task i with (n,i)∈A.

$${z}_{\text{?}}^{\text{?}} = {\sum }_{u = 1}^{\text{?}} {\text{?}}_{ui}^{\text{?}} ∀ i ∈ 𝒯 , n ∈ {𝒲}^{i} , ( n , i ) ∈ 𝒜 \qquad ( 20 )$$

$${\text{?}}_{ui}^{n} {P}_{u}^{n} \leq {t}_{i} ∀ i ∈ 𝒯 , n ∈ {𝒲}^{i} , ( n , i ) ∈ 𝒜 \qquad ( 21 )$$

$${t}_{i} + {s}_{i}^{n} \leq {q}_{\text{?}}^{n} {v}_{\text{?}}^{\text{?}} + ( 1 - {\text{?}}_{\text{?}}^{n} ) {M}_{\text{?}}^{shift} ∀ i ∈ 𝒯 , n ∈ {𝒲}^{i} , ( n , i ) ∈ 𝒜 \qquad ( 22 )$$

$${M}_{\text{?}}^{shift} = {\text{?}}_{i} + {max}_{n , \text{?}} {s}_{\text{?}}^{n} \qquad ( 23 )$$

$$\text{?} \text{indicates text missing or illegible when filed}$$

Constraints (21), (22) ensure that task i is completed in a time interval

$$[ {p}_{\text{?}}^{n} , {q}_{\text{?}}^{n} ] .$$

$$\text{?} \text{indicates text missing or illegible when filed}$$

When Iⁿ=1, the techniques described herein may include only considering start time/end time every day without any break for technician n.
Case 2: Assume task i is interruptible. In the example case, the techniques described herein may include refraining from assigning a technician with open shift hour requirement to interruptible tasks, and instead sending a regular technician (e.g., only sending a regular technician). To do so, in the example case, the techniques described herein may disallow a connection in the matrix A. Because the number of interruptible tasks is typically small, the impact of the interruptible tasks in the overall plan may be relatively minimal.

Within-slot breaks: Technician can finish a task, take a coffee break, and then go to another task (not necessarily going to home).

Assume that task i is un-interruptible, it is completely executed in a shift open hours

$$[ {p}_{\text{?}}^{n} , {q}_{\text{?}}^{n} ]$$

$$\text{?} \text{indicates text missing or illegible when filed}$$

for some u. “un-interruptible” means that the technician only allows to take a lunch break. The systems and techniques described herein may enforce following equations for technician n with shift open hours, then for relevant task i with (n,i)∈A.

$${z}_{i}^{n} = {\sum }_{u = 1}^{\text{?}} {v}_{ni}^{n} ∀ i ∈ 𝒯 , n ∈ {𝒲}^{i} , ( n , i ) ∈ 𝒜 \qquad ( 24 )$$

$${\text{?}}_{ui}^{n} {p}_{u}^{n} \leq {t}_{i} ∀ i ∈ 𝒯 , n ∈ {𝒲}^{i} , ( n , i ) ∈ 𝒜 \qquad ( 25 )$$

$${t}_{i} + {s}_{i}^{i} \leq {q}_{u}^{n} {v}_{ui}^{n} + ( 1 - {v}_{ui}^{n} ) {M}_{ui}^{shift} ∀ i ∈ 𝒯 , n ∈ {𝒲}^{i} , ( n , i ) ∈ 𝒜 \qquad ( 26 )$$

$$if {t}_{i} + {s}_{\text{?}}^{n} + {d}_{ij} \geq {q}_{\text{?}}^{\text{?}} \to {t}_{i} + {s}_{i}^{n} + {d}_{ij} + ( {p}_{n + 1}^{\text{?}} - {q}_{\text{?}}^{\text{?}} ) - {t}_{j} \leq ( 2 - {v}_{\text{?}}^{\text{?}} - {v}_{u + 1 , \text{?}}^{\text{?}} ) {M}_{2} \qquad ( 27 )$$

$$( n , i ) , ( n , j ) , ( i , j ) ∈ 𝒜$$

$${M}_{\text{?}}^{\text{?}} = {\text{?}}_{\text{?}} + {max}_{n , \text{?}} {s}_{\text{?}}^{n} \qquad ( 28 )$$

$$\text{?} \text{indicates text missing or illegible when filed}$$

Constraints (25), (26) ensure that task i is completed in a time interval

$$[ {p}_{\text{?}}^{n} , {q}_{\text{?}}^{n} ] .$$

$$\text{?} \text{indicates text missing or illegible when filed}$$

Constraints (27) ensures that there is enough time to travel from task i to task j with a break

$$[ {q}_{\text{?}}^{n} , {p}_{u + 1}^{n} ]$$

$$\text{?} \text{indicates text missing or illegible when filed}$$

in the between two open intervals. When Iⁿ=1, the techniques described herein may include considering start time/end time every day without considering any break for technician n.

A weekly backlog and consider the high priority in the objective (first in time): Case 1 (enough resources):

$$\frac{{\sum }_{n ∈ {W}^{\text{?}}} {z}_{\text{?}}^{n}}{{r}_{i}} = 1 , ∀ i ∈ {𝒯}^{\text{?}} \qquad ( 29 )$$

$$\text{?} \text{indicates text missing or illegible when filed}$$

Then the techniques described herein include minimizing start times tᵢ.

$${\sum }_{i ∈ {𝒯}^{\text{?}}} {t}_{\text{?}} \qquad ( 30 )$$

$$\text{?} \text{indicates text missing or illegible when filed}$$

Case 2 (not enough resources): This example case incurs a high cost for unperformed tasks.

$$( 1 - {\sum }_{i ∈ {\text{?}}^{\text{?}}} \frac{{\sum }_{n ∈ {𝒲}^{\text{?}}} {\text{?}}_{\text{?}}^{\text{?}}}{{r}_{i}} ) + {\sum }_{\text{?} ∈ {𝒯}^{\text{?}}} {\text{?}}_{\text{?}} \qquad ( 31 )$$

$$where$$

$${\text{?}}_{\text{?}} \geq 0 ∀ i ∈ {𝒯}^{big} \qquad ( 32 )$$

$${\text{?}}_{\text{?}} \leq T \frac{{\sum }_{n ∈ {\text{?}}^{\text{?}}} {z}_{i}^{n}}{{r}_{\text{?}}} ∀ i ∈ {𝒯}^{big} \qquad ( 33 )$$

$${\text{?}}_{\text{?}} \geq {\text{?}}_{\text{?}} - T ( 1 - \frac{{\sum }_{\text{?} ∈ {𝒲}^{\text{?}}} {z}_{i}^{\text{?}}}{{r}_{\text{?}}} ) ∀ i ∈ {𝒯}^{big} \qquad ( 34 )$$

$${\text{?}}_{\text{?}} \geq {\text{?}}_{\text{?}} + T ( 1 - \frac{{\sum }_{\text{?} ∈ {𝒲}^{\text{?}}} {z}_{i}^{\text{?}}}{{r}_{\text{?}}} ) ∀ i ∈ {𝒯}^{big} \qquad ( 35 )$$

$$\text{?} \text{indicates text missing or illegible when filed}$$

Here the techniques described herein may use new variable fito model

$${t}_{\text{?}} = {t}_{\text{?}} \frac{{\sum }_{n ∈ \text{?}} {z}_{\text{?}}}{{\text{?}}_{\text{?}}}$$

$$\text{?} \text{indicates text missing or illegible when filed}$$

using the fact that

$$\frac{{\sum }_{\text{?}} {z}_{\text{?}}^{\text{?}}}{{r}_{\text{?}}} ∈ \{ 0 , 1 \} , 0 \leq {t}_{\text{?}} \leq T .$$

$$\text{?} \text{indicates text missing or illegible when filed}$$

Detailed explanations for objectives (modeling of objective function):

### Total Cost of Technician Resource Utilization:

$${\sum }_{i ∈ 𝒯 , n ∉ {𝒲}^{\text{?}}} {c}_{i}^{\text{?}} {\text{?}}_{i}^{n} \qquad ( 36 )$$

$$\text{?} \text{indicates text missing or illegible when filed}$$

The over-skilled cost for a technician n performing task i is included in^{c}^{ᵢ}^{ⁿ}.

### Total Travel Cost:

$${\sum }_{( i , j ) ∈ 𝒜 , n ∈ 𝒲} {d}_{ij} {\text{?}}_{ij}^{n} \qquad ( 37 )$$

$$\text{?} \text{indicates text missing or illegible when filed}$$

Value of completing task i:

$${\sum }_{i ∈ 𝒯} {g}_{\text{?}} \frac{{\sum }_{n ∈ {𝒲}^{\text{?}}} {z}_{\text{?}}^{n}}{{r}_{i}} \qquad ( 38 )$$

$$\text{?} \text{indicates text missing or illegible when filed}$$

For every task there is only one type of technicians of one skill level required, i.e., given i requires rᵢ of technicians of type t and at least level l.

### Minimize End Times of Tasks i:

$${\sum }_{i ∈ 𝒯} {t}_{i} \qquad ( 39 )$$

The techniques described herein may be performed under an assumption that when a task is kicked off, the task should be completed as soon as possible. Hence the techniques described herein may include minimizing the start times where it is assumed tᵢ=0 for i∈W or task i is unperformed.

Total Excess Time Spent by Technicians Beyond their Shift End Times:

$${\sum }_{n ∈ 𝒲} {t}_{over}^{n} \qquad ( 40 )$$

The systems and techniques described herein model “minimizing change an existing routing plan” as the requirement of minimal deviation from the start time for the scheduled projects and scheduled technician-task assignments. Define Wsch by the set of scheduled technicians, T sch by the set of scheduled tasks with scheduled start time t_{i,sch},i∈T^{sch}. The systems and techniques described herein may use the same technique as in Case 2 (not enough resources) of “A weekly backlog”

$${\sum }_{n ∈ {𝒲}^{sch} , i ∈ {𝒯}^{sch}} ( 1 - {z}_{i}^{n} ) + {\sum }_{i ∈ {𝒯}^{sch}} \vert {t}_{i , sch} \frac{{\sum }_{n ∈ {𝒲}^{i}} {z}_{i}^{n}}{{r}^{i}} - {\overline{t}}_{i} \vert \qquad ( 41 )$$

$$where$$

$$\begin{matrix}{\overline{t}}_{i} \geq 0 & ∀ i ∈ {𝒯}^{sch}\end{matrix} \qquad ( 42 )$$

$$\begin{matrix}{\overline{t}}_{i} \leq T \frac{{\sum }_{n ∈ {𝒲}^{i}} {z}_{i}^{n}}{{r}^{i}} & ∀ i ∈ {𝒯}^{sch}\end{matrix} \qquad ( 43 )$$

$$\begin{matrix}{\overline{t}}_{i} \geq {t}_{i} - T ( 1 - \frac{{\sum }_{n ∈ {𝒲}^{i}} {z}_{i}^{n}}{{r}^{i}} ) & ∀ i ∈ {𝒯}^{sch}\end{matrix} \qquad ( 44 )$$

$$\begin{matrix}{\overline{t}}_{i} \leq {t}_{i} + T ( 1 - \frac{{\sum }_{n ∈ {𝒲}^{i}} {z}_{i}^{n}}{{r}^{i}} ) & ∀ i ∈ {𝒯}^{sch}\end{matrix} \qquad ( 45 )$$

### Multi-Day Scheduling

Case 1: (interruptible tasks on several days) In the example case, the techniques described herein may account for (e.g., may need to account for) driving time from the location to first job of a day and from last job of a day to the end location, i.e., fincludetraveltime=true. The systems and techniques described herein model the costs of travel from the on-going task to the end location and the from the start location to the on-going task for the next day. Under an assumption of the case without requirement arriving at the end location by T_{day}×d:
if

$${T}_{day} \times d ∈ ( {t}_{i} , {t}_{i} + {z}_{i}^{n} {s}_{i}^{n} )$$

then incurring additional cost dᵢₙ+dₙᵢ.

Note that

$${T}_{day} \times d ∈ ( {t}_{i} , {t}_{i} + {z}_{i}^{n} {s}_{i}^{n} ) ⇔ {T}_{day} \times d ∈ ( {t}_{i} , {t}_{i} + {s}_{i}^{n} ) \& {z}_{i}^{n} = 1.$$

The systems and techniques described herein introduce new variables yᵢ∈{0, 1}, i∈T, and dᵢ ∈{1, . . . , D−1} to model:

$$if {t}_{i} < {d}_{i} * {T}_{day} then {y}_{i} = 1. \qquad ( 46 )$$

The logical constraint (46) is equivalent to:

$$- T {y}_{i} \leq {t}_{i} - {d}_{i} * {T}_{day} \leq T ( 1 - {y}_{i} ) - ϵ \qquad ( 47 )$$

ϵ is a small positive tolerance, e.g., ϵ=10⁻⁶. The systems and techniques described herein introduce new variables

$${\hat{y}}_{i}^{n} ∈ \{ 0 , 1 \} ,$$

n∈W, i∈T to model the end of the task:

$$if {t}_{i} + {z}_{i}^{n} {s}_{i}^{n} > {d}_{i} * {T}_{day} then {\hat{y}}_{i}^{n} = 1. \qquad ( 48 )$$

The logical constraint (48) is equivalent to:

$$- ( T + {max}_{( n , i ) ∈ 𝒜} {s}_{i}^{n} ) {\hat{y}}_{i}^{n} \leq {d}_{i} * {T}_{day} - {t}_{i} - {z}_{i}^{n} {s}_{i}^{n} \leq ( T + {max}_{( n , i ) ∈ 𝒜} {s}_{i}^{n} ) ( 1 - {\hat{y}}_{i}^{n} ) - ϵ \qquad ( 49 )$$

Hence, if yᵢ=y\hat{ }ᵢⁿ=1, the techniques described herein include adding the cost ⁻yᵢⁿ(dᵢₙ+dₙᵢ)=yᵢ*y\hat{ }ᵢⁿ(dᵢₙ+dₙᵢ), where ⁻y″∈{0,1} is a binary variable satisfying:

$$\begin{matrix}{\overline{y}}_{i}^{n} \leq {y}_{i} & ∀ i ∈ 𝒯\end{matrix} , n ∈ 𝒲 \qquad ( 50 )$$

$$\begin{matrix}{\overline{y}}_{i}^{n} \leq {\hat{y}}_{i}^{n} & ∀ i ∈ 𝒯\end{matrix} , n ∈ 𝒲 \qquad ( 51 )$$

$$\begin{matrix}{\overline{y}}_{i}^{n} \geq {y}_{i} + {\hat{y}}_{i}^{n} - 1 & ∀ i ∈ 𝒯\end{matrix} , n ∈ 𝒲 \qquad ( 52 )$$

For the case to requiring arriving at the end location by T_{day}×d, the techniques described herein include considering the following logic:
if

$${T}_{day} \times d ∈ ( {t}_{i} + {z}_{i}^{n} {d}_{in} , {t}_{i} + {z}_{i}^{n} ( {s}_{i}^{n} + {d}_{in} ) )$$

then incurring additional cost dᵢₙ+dₙᵢ.
Case 2: (un-interruptible tasks) In example embodiments, this case is handled through constraints. The systems and techniques described herein may use the same technique as Case 1 of “Visit site open hours” where Tₒₚₑₙⁱ=D−1, [b₁ᵢ, e₁ᵢ]=[0,T_{day}], [b₂ᵢ, e₂ᵢ]=[T_{day}, 2T_{day}], . . . , [b_{Di}, e_{Di}]=[(D−1)*T_{day},D*T_{day}] is defined for task i.

The techniques described herein include minimizing the total cost for two cases:
Case 1 (enough resources for backlog tasks):

$${α}_{1} {\sum }_{i ∈ 𝒯 , n ∈ {𝒲}^{i}} {c}_{n} {z}_{i}^{n} + {α}_{2} {\sum }_{( i , j ) ∈ 𝒜 , n ∈ 𝒲} {d}_{ij} {x}_{ij}^{n} - {α}_{3} {\sum }_{i ∈ 𝒯} {g}_{i} \frac{{\sum }_{n ∈ {𝒲}^{i}} {z}_{i}^{n}}{{r}_{i}} + {α}_{4} {\sum }_{i ∈ 𝒯} {t}_{i} + {α}_{5} {\sum }_{n ∈ 𝒲} {t}_{over}^{n} + {α}_{6} {\sum }_{n ∈ {𝒲}^{sch} , i ∈ {𝒯}^{sch}} ( 1 - {z}_{i}^{n} ) + {α}_{7} {\sum }_{i ∈ {𝒯}^{sch}} \vert {t}_{i , sch} \frac{{\sum }_{n ∈ {𝒲}^{i}} {z}_{i}^{n}}{{r}_{i}} - {\overline{t}}_{i} \vert + {α}_{7} {\sum }_{i ∈ {𝒯}^{blg}} {t}_{i} \qquad ( 53 )$$

Case 2 (not enough resources for backlog tasks):

$${α}_{1} {\sum }_{i ∈ 𝒯 , n ∈ {𝒲}^{i}} {c}_{n} {z}_{i}^{n} + {α}_{2} {\sum }_{( i , j ) ∈ 𝒜 , n ∈ 𝒲} {d}_{ij} {x}_{ij}^{n} - {α}_{3} {\sum }_{i ∈ 𝒯} {g}_{i} \frac{{\sum }_{n ∈ {𝒲}^{i}} {z}_{i}^{n}}{{r}_{i}} + {α}_{4} {\sum }_{i ∈ 𝒯} {t}_{i} + {α}_{5} {\sum }_{n ∈ 𝒲} {t}_{over}^{n} + {α}_{6} {\sum }_{n ∈ {𝒲}^{sch} , i ∈ {𝒯}^{sch}} ( 1 - {z}_{i}^{n} ) + {α}_{7} {\sum }_{i ∈ {𝒯}^{sch}} \vert {t}_{i , sch} \frac{{\sum }_{n ∈ {𝒲}^{i}} {z}_{i}^{n}}{{r}_{i}} - {\overline{t}}_{i} \vert + {α}_{8} {\sum }_{i ∈ {𝒯}^{blg}} {\hat{t}}_{i} + {α}_{9} ( 1 - {\sum }_{i ∈ {𝒯}^{blg}} \frac{{\sum }_{n ∈ {𝒲}^{i}} {z}_{i}^{n}}{{r}_{i}} ) \qquad ( 54 )$$

for some αᵢ>0.

In view of the following example aspects about the model, the systems and techniques described herein may support some alternative and/or additional embodiments and approaches for an efficient implementation.

In one embodiment, to deal with large numeric values for speeding up a MILP solver, the systems and techniques described herein may include converting 1 second block to 5 minute block, i.e., dividing time columns by 300.

In one embodiment, for readability purpose, the systems and techniques described herein may use 0-1 variable

$${z}_{i}^{n} ,$$

but for scalability when implementing the model, the techniques described herein can remove the variable because

$${z}_{i}^{n} = {\sum }_{j ∈ {𝒩}_{i}^{out}} {x}_{ij}^{n} .$$

In one embodiment, zᵢⁿ can be equivalently relaxed to be in the nonnegative real number set R₊ because

$${\sum }_{j ∈ {𝒩}_{i}^{out}} {x}_{ij}^{n} ∈ \{ 0 , 1 \} .$$

In one embodiment, the model handles both cases: the same start and end location/depot for a technician and different start and end locations. Because the techniques provided herein may be implemented with only the information dₙᵢ and dᵢₙ; dₙᵢ captures the travel of the technician from the start location to the first task, dᵢₙ models the travel from the last task to the end location.

In one embodiment, if not modeling the time before the first customer visit and after the last customer visit (shift starts at the first visit) for tasks, the techniques described herein may include setting dₙᵢ=0 for every n∈W,i∈T, (n,i)∈A and dᵢₙ=0 for every j∈T, n∈W, (j,n)∈A.

In one embodiment, for a long task over several days, set d=0.

In one embodiment, the performance of a MILP solver depends on a good initial solution; that is warm-start to provide an initial upper bound in the branch-and-bound tree. The systems and techniques described herein can use the final solution from an AI constraint solver (e.g., OptaPlanner) as the initial solution or design a simple heuristics. A simple heuristics is that at the beginning of the scheduling horizon, the systems and techniques described herein may include deploying all available technicians to urgent tasks with the shortest distances. For any technician who completes a task, direct to the nearest urgent tasks. After completing urgent tasks, technicians move to backlog/high priority tasks, then the regular tasks. For any move, consider operational constraints such as un-interruptible tasks, site open hours, technician shift open hours, synchronized visits etc.

In one embodiment, further aspects of the present disclosure may support further investigation how to select values for big M, objective function weights αᵢ. Further aspects of the present disclosure may support further investigation exploring how a MILP solver (e.g., MILP solver 215) handles multiple objectives.

In one embodiment, uncertainty for service times and driving times can be modeled as robust optimization when the uncertainty sets are box constraints for s and d.

TABLE 2
Notation for the MILP model

Indices

| | |
|---|---|
| i, j, | tasks |
| n, | depot |

Sets

| | |
|---|---|
| [symbol] , | tasks that need to be addressed |
| [symbol] ^{blg}, | backlog tasks with the high priority (first in time) |
| [symbol] ^{int}, | tasks that can be interrupted |
| [symbol] ^{o}, | tasks with site open hours |
| [symbol] , | set of depots with homogeneous technicians |
| [symbol] i, | eligible set of depots whose techicians can address some aspects of task i |
| [symbol] | set of depots whose technicians have “within shift breaks” |
| [symbol] | set of “within shift breaks” for depot n, whose elements are $[ {q}_{d}^{n} , {p}_{d + 1}^{n} ] ∈ {ℬ}^{n} , d \leq \vert 𝒟 \vert - 1$ |
| ${𝒲}_{sync}^{i} ,$ | set of synchronized tasks for task i |
| [symbol] , | = [symbol] ∪ [symbol] |
| [symbol] , | feasible arcs in the location graph of work orders and technicians |
| ${𝒩}_{i}^{in} ,$ | the set of in-neighbors of node i |
| ${𝒩}_{i}^{out} ,$ | the set of out-neighbors of node i |

Parameters

| | |
|---|---|
| [symbol] , | set of working intervals, \| [symbol] \| = maxₙ \|Iⁿ\| |
| T, | [0, T] scheduling horizon |
| T_{day}, | during of a working day, e.g. T_{day} = 8(hours) |
| t_{end}, | end time of a working day, e.g. t_{end} = 5pm |
| [symbol] , | the number of technicians at the start depot n ∈ [symbol] |
| bᵢ, | earliest start time of task i |
| eᵢ, | latest end time of task i |
| sᵢ, | service time of task i ∈ [symbol] , assume sᵢ = 0 for i ∈ [symbol] |
| rᵢ, | number of technicians of type t of minimum skill level l needed for task i |
| dᵢⱼ, | driving time between task or technician i ∈ [symbol] ∪ [symbol] to task or technician j ∈ [symbol] ∪ [symbol] |
| gᵢ, | value of completing task i - combine service time duration, priority |
| M, | ma [symbol] (eᵢ − dᵢⱼ) |
| ${c}_{i}^{n} ,$ | cost associated with a technician at depot n to perform task i |
| ${p}_{d}^{n} ,$ | start of available times for a technician at depot n for d ∈ [symbol] |
| ${q}_{d}^{n} ,$ | end of available times for a technician at depot n for d ∈ [symbol] |
| I^{n,} | the number of open time slots for technicians at depot n |
| ${b}_{i}^{o} ,$ | start of available times for task i for o = 1, . . . , ${T}_{open}^{i}$ |
| ${e}_{i}^{o} ,$ | end of available times for task i for o = 1, . . . , ${T}_{open}^{i}$ |
| ${T}_{open}^{i} ,$ | the number of open time slots for task i, ${o}_{max} = {max}_{i} {T}_{open}^{i}$ |

Decision Variables

| | |
|---|---|
| tᵢ, | $( ∈ {ℝ}_{+}^{\vert \dot{𝒩} \vert} , i ∈ \dot{𝒩} ) global start time of task i across technicians ,$ |
| | assume tᵢ = 0 for i ∈ [symbol] or task i is unperformed. |
| xᵢⱼ, | (∈ {0, 1 [symbol] ) binary variable if the arc from node i ∈ [symbol] to node j ∈ [symbol] is used; |
| | $i ∈ 𝒲 ⋃ {𝒯}_{W}^{1} ⋃ … ⋃ {𝒯}_{W}^{D - 1} and j ∈ {𝒯}_{W}^{1} ⋃ … ⋃ {𝒯}_{W}^{D}$ |
| ${z}_{i}^{n} ,$ | (∈ {0, 1}^{\|} [symbol] ^{\|}) if task i ∈ [symbol] is performed by a technician in depot n ∈ [symbol] |
| ${v}_{i}^{d} ,$ | (∈{0, 1}, i ∈ [symbol] , d ∈ [symbol] ) if task n is performed at the d-th shift time slot |
| ${ξ}_{i}^{o} ,$ | (∈ {0, 1}, i ∈ [symbol] , o ∈ 1, . . . , oₘₐₓ) if task i is performed at the o-th open task slot |

[symbol]

indicates data missing or illegible when filed

### Two-Index Formulation

Assumption 1: The service time sᵢ of task i∈T does not depend on technician level, i.e., no needs sᵢⁿ. Assumption 2: There is at most one technician to perform a task i E T during the scheduling horizon T, i.e., rᵢ=1 for all i∈T.

The systems and techniques described herein introduce a mixed-integer linear program (MILP) for solving the dispatching problem. The systems and techniques described herein consider a network (N,A) including a set of technicians W and set of tasks T as a directed graph without self-loops, where N=W∪T is the set of nodes and A ⊆N×N is the set of directed arcs. Denote

$${𝒩}_{i}^{i n}$$

by the set of in-neighbors of node

$$i ( i . e . , {𝒩}_{i}^{i n} = \{ j ∈ 𝒩 \vert ( j , i ) ∈ 𝒜 \} ) .$$

### Denote

$${𝒩}_{i}^{out}$$

by the set of out-neighbors or node i

$$( i . e . , {𝒩}_{i}^{out} = \{ j ∈ 𝒩 \vert ( i , j ) ∈ 𝒜 \} ) .$$

The assignment of the n-th technician (n∈W) to each task i located at node i∈T is characterized by two parameters: start time t₁ and service duration sᵢ. Travel time from node i to node j is d_{i,j}. The systems and techniques described herein may be implemented under an example assumption that each technician n begins his/her shift at the start location and returns to the end location or finish the last task no later than the time horizon T. The schedule time is assumed to start at time 0 for the planning horizon T, and the scheduling problem is for D days.

To make a MILP scalable, the systems and techniques described herein support providing a formulation with the least number of variables, especially binary variables, and the least number of constraints. To do so, pre-processing is a crucial step to reduce the size of the problem. The systems and techniques described herein suggest the following.

The systems and techniques described herein may include pre-processing the set of directed arcs A to account for unacceptable moves (also referred to herein as invalid moves) in the graph such as precedence constraints (i.e., dependency between visits), technician style-task matching, not allowed to travel between depots, no self-loops, enough time to travel between tasks (i.e., removing (i,j) such that

$${b}_{i} + {min}_{n ∈ Wi} ( {s}^{n} i ) + {d}_{ij} > {min}_{n ∈ Wj ( \begin{matrix}sn \\ j\end{matrix} )} + {e}_{j} ) .$$

The systems and techniques described herein may be implemented under an assumption that if there are technician precedence constraints for a task, it is divided into multiple tasks.

To track the location of a technician for the end of a working day over D days, the systems and techniques described herein define an artificial set of tasks T_{W}^{d} for the end of each day d∈{1, . . . , [D]}, which reserves a location for the technicians from the same depot as the end location for each day. Each task in T_{W}^{d} is uniquely related to a start depot. The systems and techniques described herein may be implemented under assumptions that if the service time for any task in 7w is zero, the travel time d_{i,j} between any

$$i ∈ {𝒯}_{W}^{{d}_{1}} and j ∈ {𝒯}_{W}^{{d}_{2}}$$

is zero with i=j and d₂>d₁. There is no arc between technician locations, that is, if

$$i ∈ {𝒯}_{W}^{{d}_{1}} , j ∈ {𝒯}_{W}^{{d}_{2}} , {d}_{2} \leq {d}_{1} or$$

$$i ∈ {𝒯}_{W}^{{d}_{1}} , j ∈ {𝒯}_{W}^{{d}_{2}} , {d}_{1} < {d}_{2} , i \neq j .$$

Assume the site open hours for every i∈T_{W}^{d} is [24*(d−1)+t_{end}−ϵ, T] for any d=0,1, . . . , D (where T_{W}⁰, W). For technicians with shift open hours

$$[ {p}_{d}^{n} , {q}_{d}^{n} ] ,$$

the systems and techniques described herein may follow the same mechanism where the site open hours is

$$[ {q}_{d}^{n} - ϵ , T ] ,$$

service time is zero. Hence the artificial tasks have the feature: earliest start time (i.e.,

$${b}_{i} = {q}_{d}^{n} - ϵ or$$

$$24 * ( d - 1 ) + {t}_{end} - ϵ , d \geq 1 )$$

and the latest end time eᵢ=T. The small value for its used to make a nonzero overlap between the shift open hour

$$[ {p}_{d}^{n} , {q}_{d}^{n} ]$$

from the associated technicians and the site open hour

$$[ {q}_{d}^{n} - ϵ , T ]$$

of the artificial task.

The systems and techniques described herein define:

$${𝒯}^{′} = 𝒯 ⋃ {𝒯}_{W}^{1} ⋃ … ⋃ {𝒯}_{W}^{D} , and$$

$${𝒩}^{′} = 𝒲 ⋃ {𝒯}^{′} .$$

In the following, embodiments of the present disclosure are described with reference to an extended network (N^{\hat{ }},A^{\hat{ }}). T_{W}^{d} (n) which corresponds to the artificial task of depot n at the end of day d.

In the data model, fincludetraveltime is used to include travel time between depots and tasks. If fincludetraveltime=0, the techniques described herein may include assigning dᵢⱼ=0 for every:

$$i ∈ 𝒲 ⋃ {𝒯}_{W}^{1} ⋃ … ⋃ {𝒯}_{W}^{D - 1} or$$

$$j ∈ {𝒯}_{W}^{1} ⋃ … ⋃ {𝒯}_{W}^{D} .$$

In some aspects, the systems and techniques described herein may assume that all technicians at depot n∈W are deployed during the scheduling horizon, including deployed to an artificial task. All technician will finish the trip at the artificial task T_{W}^{D}(n) at the end of scheduling horizon. For example, if a technician is not deployed in reality, the systems and techniques described herein can model the deployment by requiring the technician move directly to perform the last artificial task T_{W}^{D}(n). In some examples, the systems and techniques described herein may operate under an assumption that the last artificial task T_{W}^{D}(n) needs wⁿ technicians to perform and it is always performed.

The travel time constraint (62) requires all values tᵢ for every i∈N°. In terms of defining decision variables for tᵢ, the systems and techniques described herein may consider those in T as unknown, and using a fixed value for

$$i ∈ {𝒯}_{W}^{1} : {t}_{i} = {q}_{d}^{n} - \frac{ϵ}{2} .$$

An example of MILP formulation (e.g., formation of a MILP model 417) in accordance with one or more embodiments of the present disclosure is described herein with reference to Equations (55) through (84).

### Detailed Explanations for Constraints:

Consistency between depot-to-task and task-to-task assignments for every task i∈T:

$${\sum }_{n ∈ 𝒲} {z}_{i}^{n} = {\sum }_{l ∈ {\hat{𝒩}}_{i}^{in}} {x}_{li} , ∀ i ∈ \hat{𝒯} \qquad ( 55 )$$

All wⁿ technicians are deployed from the start location n∈W.

$${\sum }_{j ∈ {𝒩}_{n}^{out}} {x}_{nj} = {w}^{n} , ∀ n ∈ 𝒲 \qquad ( 56 )$$

Real task i∈T is performed by at most one technician.

$${\sum }_{j ∈ {\hat{𝒩}}_{i}^{out}} {x}_{ij} \leq 1 ( i . e . , {\sum }_{n ∈ 𝒲} {z}_{i}^{n} \leq 1 ) , ∀ i ∈ 𝒯 \qquad ( 57 )$$

### Flow Balance Equations:

The move of a technician to tasks is modelled as:

$$\begin{matrix}{z}_{i}^{n} \geq {x}_{ni} , & ∀ i ∈ \hat{𝒯}\end{matrix} , n ∈ 𝒲 \qquad ( 58 )$$

$$\begin{matrix}{z}_{j}^{n} \geq {z}_{i}^{n} + {x}_{ij} - 1 , & ∀ ( i , j ) ∈ \hat{𝒯} , n ∈ 𝒲 .\end{matrix} \qquad ( 59 )$$

Replacing the above by the whole network (N^{\hat{ }},A^{\hat{ }}), the conservation of technician flow for each intermediate node

$$i ∈ 𝒯 ⋃ {𝒯}_{W}^{1} ⋃ … ⋃ {𝒯}_{W}^{D - 1}$$

is:

$${\sum }_{i : ( i , j ) ∈ \hat{𝒜}} {x}_{ij} = {\sum }_{i : ( j , i ) ∈ \hat{𝒜}} {x}_{ji} , ∀ i ∈ 𝒯 ⋃ {𝒯}_{W}^{1} ⋃ … ⋃ {𝒯}_{W}^{D - 1} \qquad ( 60 )$$

In an example, the last artificial task j^{ϵT}_{W}^{D} needs wⁿ technicians to perform, and the techniques described herein may include ensuring that the last artificial task is always performed.

$${\sum }_{j : ( i , j ) ∈ \hat{𝒜}} {x}_{ij} = {w}^{n} , ∀ j ∈ {𝒯}_{W}^{D} \qquad ( 61 )$$

where T_{W}^{D}(n)=j.

For tasks i,j, the previous service time sᵢ plus driving time dᵢⱼ is less than the next start time tⱼ.

$${t}_{i} + {s}_{i} + {d}_{ij} - {t}_{j} \leq ( 1 - {x}_{ij} ) M , ∀ ( i , j ) ∈ 𝒜 , i ∈ 𝒲 ⋃ {𝒯}_{W}^{1} ⋃ … ⋃ {𝒯}_{W}^{D - 1} , j ∈ {𝒯}_{W}^{1} ⋃ … ⋃ {𝒯}_{W}^{D} \qquad ( 62 )$$

If i∈W, it may be assumed that tᵢ=sᵢ=0. If i∈T_{W}^{d}, and a fixed value may be used for

$${t}_{i} = {q}_{d}^{n} - \frac{ϵ}{2} .$$

Model the working pattern of technicians: “multi-day”, “shift open hours”, and “within-shift breaks”. Without loss of generality, the systems and techniques described herein may support assumptions that every technician in depot n has |D| shift open hours [pⁿ_{d},q_{d}ⁿ], d∈D. For a depot n∈W_{B}, technicians have “within-shift breaks”

$$[ {q}_{d}^{n} , {p}_{d + 1}^{n} ] ∈ {B}_{n} , d \leq \vert D \vert - 1.$$

Matching time availability between task i and depot n is written as:

$${\sum }_{d ∈ 𝒟} {v}_{i}^{d} {p}_{d}^{n} \leq {t}_{i} + {M}_{1} ( 1 - {z}_{i}^{n} ) , ∀ i ∈ 𝒯 , n ∈ 𝒲 \qquad ( 63 )$$

$${\sum }_{n ∈ {𝒲}^{i}} {z}_{i}^{n} = {\sum }_{d ∈ 𝒟} {v}_{i}^{d} , ∀ i ∈ \hat{𝒯} \qquad ( 64 )$$

If fincludetraveltime=0:

$${t}_{i} + {s}_{i} \leq {\sum }_{d ∈ 𝒟} {v}_{i}^{d} {q}_{d}^{n} + {M}_{2} ( 1 - {z}_{i}^{n} ) , ∀ i ∈ 𝒯 , n ∈ 𝒲 \qquad ( 65 )$$

If fincludetraveltime=1:

$${t}_{i} + {s}_{i} + {z}_{i}^{n} {d}_{in} \leq {\sum }_{d ∈ 𝒟} {v}_{i}^{d} {q}_{d}^{n} + {M}_{2} ( 1 - {z}_{i}^{n} ) , ∀ i ∈ 𝒯 , n ∈ 𝒲 \qquad ( 66 )$$

The systems and techniques described herein may include imposing the driving time after the break for the within-shift break case. For n∈W_{B} and real tasks i,j∈T,

$$i f {t}_{i} + {s}_{i} + {d}_{ij} \geq {\sum }_{[ {q}_{d}^{n} , {p}_{d + 1}^{n} ] ∈ {ℬ}^{n} , d \leq \vert 𝒟 \vert - 1} {v}_{i}^{d} {q}_{d}^{n} \to {d}_{ij} + {\sum }_{[ {q}_{d}^{n} , {p}_{d + 1}^{n} ] ∈ {ℬ}^{n} , d \leq \vert 𝒟 \vert - 1} {v}_{i}^{d + 1} {p}_{d + 1}^{n} \leq {t}_{j} + ( 1 - {x}_{ij} ) {M}_{3} , n ∈ {𝒲}_{B} , i , j ∈ 𝒯 , ( n , i ) , ( n , j ) , ( i , j ) ∈ 𝒜 \qquad ( 67 )$$

Earliest start time and latest end time of task i (assume Tₒₚₑₙⁱ=1). Note that all artificial tasks have the requirement.

$$\begin{matrix}{b}_{i} {\sum }_{n ∈ {𝒲}^{i}} {z}_{i}^{n} \leq {t}_{i} , & ∀ i ∈ 𝒯\end{matrix} \qquad ( 68 )$$

$$\begin{matrix}{t}_{i} + {s}_{i} {\sum }_{n ∈ {𝒲}^{i}} {z}_{i}^{n} \leq {e}_{i} {\sum }_{n ∈ {𝒲}^{i}} {z}_{i}^{n} , & ∀ i ∈ 𝒯\end{matrix} \qquad ( 69 )$$

Visit site open hours (assume

$${T}_{open}^{i} > 1 ) .$$

Assume that task i it is completely executed in a site open hour [b^{o}ᵢ, e^{o}ᵢ] for some

$$o ∈ \{ 1 , … , {T}_{open}^{i} \} .$$

$$\begin{matrix}{\sum }_{n ∈ 𝒲} {z}_{i}^{n} = {\sum }_{o = 1}^{{T}_{open}^{i}} {ξ}_{i}^{o} & ∀ i ∈ {𝒯}^{o}\end{matrix} \qquad ( 70 )$$

$$\begin{matrix}{\sum }_{o} {b}_{i}^{o} {ξ}_{i}^{o} \leq {t}_{i} , & ∀ i ∈ {𝒯}^{o}\end{matrix} \qquad ( 71 )$$

$$\begin{matrix}{t}_{i} + {s}_{i} {\sum }_{n ∈ 𝒲} {z}_{i}^{n} \leq {\sum }_{o} {e}_{i}^{o} {ξ}_{i}^{o} , & ∀ i ∈ {𝒯}^{o}\end{matrix} \qquad ( 72 )$$

### Synchronized Visits:

Several synchronized tasks (starting at the same time) each requesting a craft (may be different crafts and possibly each task with a different duration):

$${M}_{5} ( {\sum }_{n ∈ {𝒲}^{i}} {z}_{i}^{n} - 1 ) \leq {t}_{i} - {t}_{j} \leq {M}_{5} ( 1 - {\sum }_{n ∈ {𝒲}^{i}} {z}_{i}^{n} ) , ∀ i ∈ 𝒯 , j ∈ {𝒲}_{sync}^{i} \qquad ( 73 )$$

Here it may be assumed that for tasks i and j that are synchronized, the systems and techniques described herein consider that the tasks have to be performed at the same time if both are performed.

A weekly backlog and consider the high priority in the objective (first in time): Case 1 (enough resources):

$${\sum }_{n ∈ {𝒲}^{i}} {z}_{i}^{n} = 1 , ∀ i ∈ {𝒯}^{blg} \qquad ( 74 )$$

Then the techniques described herein include minimizing start times tᵢ:

$${\sum }_{i ∈ {𝒯}^{blg}} {t}_{i} \qquad ( 75 )$$

Case 2 (not enough resources): A high cost may be incurred for unperformed tasks:

$${\sum }_{i ∈ {𝒯}^{blg}} ( 1 - {\sum }_{n ∈ {𝒲}^{i}} {z}_{i}^{n} ) + {\sum }_{i ∈ {𝒯}^{blg}} {\hat{t}}_{i} \qquad ( 76 )$$

$$where$$

$$\begin{matrix}{\hat{t}}_{i} \geq 0 & ∀ i ∈ {𝒯}^{blg}\end{matrix} \qquad ( 77 )$$

$$\begin{matrix}{\hat{t}}_{i} \leq T {\sum }_{n ∈ {𝒲}^{i}} {z}_{i}^{n} & ∀ i ∈ {𝒯}^{blg}\end{matrix} \qquad ( 78 )$$

$$\begin{matrix}{\hat{t}}_{i} \geq {t}_{i} - T ( 1 - {\sum }_{n ∈ {𝒲}^{i}} {z}_{i}^{n} ) & ∀ i ∈ {𝒯}^{blg}\end{matrix} \qquad ( 79 )$$

$$\begin{matrix}{\hat{t}}_{i} \leq {t}_{i} - T ( 1 - {\sum }_{n ∈ {𝒲}^{i}} {z}_{i}^{n} ) & ∀ i ∈ {𝒯}^{blg}\end{matrix} \qquad ( 80 )$$

Here new variable \hat{t}ᵢ is used to model

$${\hat{t}}_{i} = {t}_{i} {\sum }_{n ∈ {𝒲}^{i}} {z}_{i}^{n}$$

using the fact that

$${\sum }_{n ∈ {𝒲}^{i}} {z}_{i}^{n} ∈ \{ 0 , 1 \} , 0 \leq {t}_{i} \leq T .$$

### Detailed Explanations for Objectives (Modeling of Objective Function):

The explanations described herein include aspects of the three-index case described herein, and repeated descriptions of like elements are omitted for brevity. They are essentially the same with the three-index case because both use variable z″ to calculate KPIs. Be careful about index sets T,T\hat{ },A\hat{ } etc. Some examples for the objective are

### Total Cost of Technician Resource Utilization:

$${\sum }_{i ∈ 𝒯 , n ∈ {𝒲}^{i}} {c}_{i}^{n} {z}_{i}^{n} \qquad ( 81 )$$

The over-skilled cost for a technician n performing task i is included in cⁿᵢ.

### Total Travel Cost:

$${\sum }_{( i , j ) ∈ \hat{𝒜}} {d}_{ij} {x}_{ij} \qquad ( 82 )$$

### Value of Completing Task i:

$${\sum }_{i ∈ 𝒯} {g}_{i} {\sum }_{n ∈ {𝒲}^{i}} {z}_{i}^{n} \qquad ( 83 )$$

### Minimize End Times of Tasks i:

$${\sum }_{i ∈ 𝒯} {t}_{i} \qquad ( 84 )$$

In some aspects, the systems and techniques described herein may be implemented under an assumption that when a task is kicked off, the task is to be completed as soon as possible. Hence, the systems and techniques described herein may include minimizing the start times where it is assumed that tᵢ=0 for i∈W or task i is unperformed.

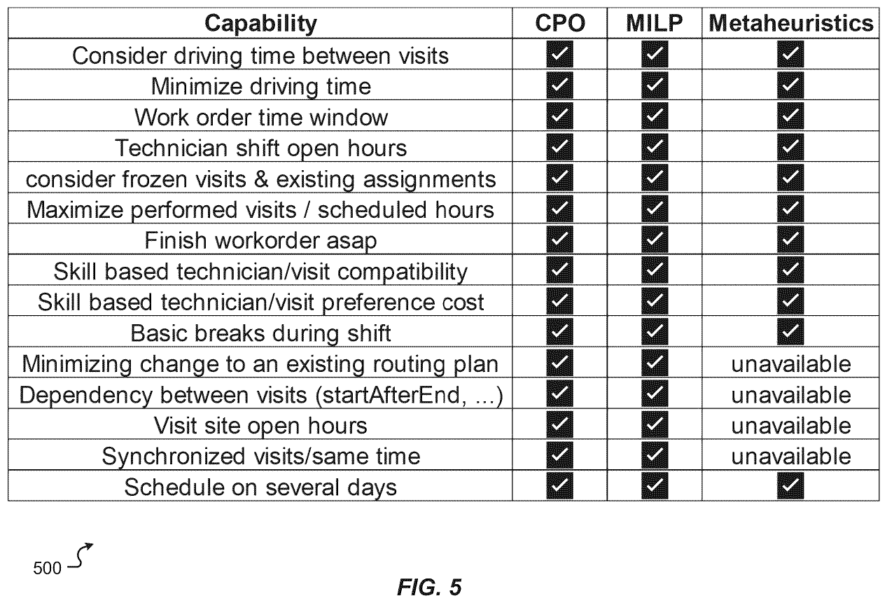

FIG. 5 illustrates a table 500 of example capabilities which the MILP solver 215 described herein may consider in association with generating a solution 225 for field workforce management and dispatching in accordance with one or more embodiments of the present disclosure, compared to the solver 220 (CPO solver) and other approaches (e.g., metaheuristics).

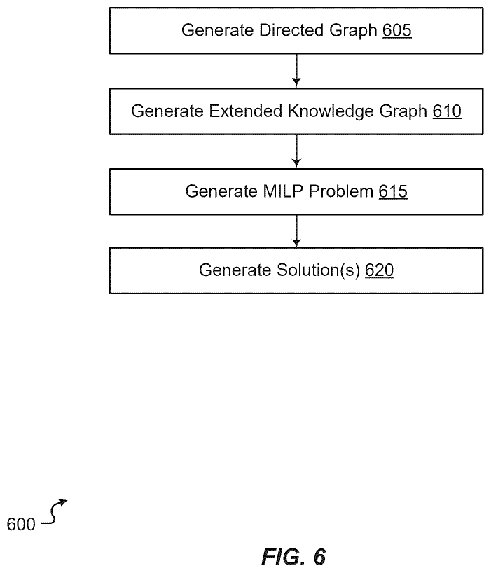

FIG. 6 illustrates an example flowchart of a method 600 that supports field workforce management and dispatching in accordance with one or more embodiments of the present disclosure.

At 605, the method 600 includes generating a directed graph associated with a set of workers, a set of customers, and a set of tasks associated with the set of customers, based on: customer information associated with the set of tasks; and resource and budget information associated with the set of customers.

At 610, the method 600 includes generating an extended knowledge graph based on the directed graph and a set of operation and business rules, where the set of operation and business rules are associated with the set of workers, the set of customers, the set of tasks, and one or more facilities associated with the set of tasks.

At 615, the method 600 includes generating, based on the extended knowledge graph, a MILP problem associated with completing the set of tasks.

At 620, the method 600 includes generating, by an MILP solver engine, one or more solutions associated with dispatching and managing the set of workers in association with solving the MILP problem.

In some aspects, the set of operation and business rules include temporal parameters associated with the set of workers, the set of customers, the set of tasks, and facility information associated with the set of tasks.

In some aspects, the set of operation and business rules include temporal windows for accessing the one or more facilities by the set of workers.

In some aspects, the one or more solutions span multiple temporal periods, multiple days, multiple depots, or a combination thereof.

In some aspects, generating the one or more solutions includes removing one or more invalid moves from the directed graph.

In some aspects: the MILP problem includes a model including the set of workers, the set of customers, the set of tasks, the customer information, the resource and budget information, and the set of operation and business rules; and generating the one or more solutions is based on the model.

In some aspects, generating the one or more solutions is based on solving a set of linear equations included in the MILP problem.

In some aspects, the method 600 may include generating an initial solution for solving the problem based on processing, by a second solving engine, input data over a target temporal duration, where generating the one or more solutions is based on processing, by the MILP solver engine, at least a portion of the initial solution.

In some aspects, the method 600 may include tracking movement of one or more workers of the set of workers to a first task, tracking movement of the one or more workers between the first task and at least one other task, or both based on the extended knowledge graph.

In some aspects, the customer information includes: a target skill for a worker of the set of workers in association with completing a task of the set of tasks; and a target temporal duration associated with completing the task.

In some aspects, the resource and budget information includes priority information associated with the set of customers.

In some aspects, the directed graph is absent self-loops.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

Various embodiments are described herein with reference to the related drawings Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
generating a directed graph associated with a set of workers, a set of customers, and a set of tasks associated with the set of customers, based on:
customer information associated with the set of tasks; and
resource and budget information associated with the set of customers;
generating an extended knowledge graph based on the directed graph and a set of operation and business rules, wherein the set of operation and business rules are associated with the set of workers, the set of customers, the set of tasks, and one or more facilities associated with the set of tasks;
generating, based on the extended knowledge graph, a mixed-integer linear program (MILP) problem associated with completing the set of tasks; and
generating, by an MILP solver engine, one or more solutions associated with dispatching and managing the set of workers in association with solving the MILP problem.

2. The computer-implemented method of claim 1, wherein the set of operation and business rules comprise temporal parameters associated with the set of workers, the set of customers, the set of tasks, and facility information associated with the set of tasks.

3. The computer-implemented method of claim 1, wherein the set of operation and business rules comprise temporal windows for accessing the one or more facilities by the set of workers.

4. The computer-implemented method of claim 1, wherein the one or more solutions span multiple temporal periods, multiple days, multiple depots, or a combination thereof.

5. The computer-implemented method of claim 1, wherein generating the one or more solutions comprises removing one or more invalid moves from the directed graph.

6. The computer-implemented method of claim 1, wherein:
the MILP problem comprises a model comprising the set of workers, the set of customers, the set of tasks, the customer information, the resource and budget information, and the set of operation and business rules; and
generating the one or more solutions is based on the model.

7. The computer-implemented method of claim 1, wherein generating the one or more solutions is based on solving a set of linear equations comprised in the MILP problem.

8. The computer-implemented method of claim 1, further comprising:
generating an initial solution for solving the problem based on processing, by a second solving engine, input data over a target temporal duration,
wherein generating the one or more solutions is based on processing, by the MILP solver engine, at least a portion of the initial solution.

9. The computer-implemented method of claim 1, further comprising:
tracking movement of one or more workers of the set of workers to a first task, tracking movement of the one or more workers between the first task and at least one other task, or both based on the extended knowledge graph.

10. The computer-implemented method of claim 1, wherein the customer information comprises:
a target skill for a worker of the set of workers in association with completing a task of the set of tasks; and
a target temporal duration associated with completing the task.

11. The computer-implemented method of claim 1, wherein the resource and budget information comprises priority information associated with the set of customers.

12. The computer-implemented method of claim 1, wherein the directed graph is absent self-loops.

2. A computing system having a memory having computer readable instructions and one or more processors for executing the computer readable instructions, the computer readable instructions controlling the one or more processors to perform operations comprising:
generating a directed graph associated with a set of workers, a set of customers, and a set of tasks associated with the set of customers, based on:
customer information associated with the set of tasks; and
resource and budget information associated with the set of customers;
generating an extended knowledge graph based on the directed graph and a set of operation and business rules, wherein the set of operation and business rules are associated with the set of workers, the set of customers, the set of tasks, and one or more facilities associated with the set of tasks;
generating, based on the extended knowledge graph, a mixed-integer linear program (MILP) problem associated with completing the set of tasks; and
generating, by an MILP solver engine, one or more solutions associated with dispatching and managing the set of workers in association with solving the MILP problem.

14. The computing system of claim 13, wherein the set of operation and business rules comprise temporal parameters associated with the set of workers, the set of customers, the set of tasks, and facility information associated with the set of tasks.

15. The computing system of claim 13, wherein the set of operation and business rules comprise temporal windows for accessing the one or more facilities by the set of workers.

16. The computing system of claim 13, wherein the one or more solutions span multiple temporal periods, multiple days, multiple depots, or a combination thereof.

17. The computing system of claim 13, wherein generating the one or more solutions comprises removing one or more invalid moves from the directed graph.

18. The computing system of claim 13, wherein:
the MILP problem comprises a model comprising the set of workers, the set of customers, the set of tasks, the customer information, the resource and budget information, and the set of operation and business rules; and
generating the one or more solutions is based on the model.

19. The computing system of claim 13, wherein generating the one or more solutions is based on solving a set of linear equations comprised in the MILP problem.

3. A computer program product comprising a computer readable storage medium having program instructions embodied therewith, the program instructions executable by a processor to cause the processor to perform operations comprising:
generating a directed graph associated with a set of workers, a set of customers, and a set of tasks associated with the set of customers, based on:
customer information associated with the set of tasks; and
resource and budget information associated with the set of customers;
generating an extended knowledge graph based on the directed graph and a set of operation and business rules, wherein the set of operation and business rules are associated with the set of workers, the set of customers, the set of tasks, and one or more facilities associated with the set of tasks;
generating, based on the extended knowledge graph, a mixed-integer linear program (MILP) problem associated with completing the set of tasks; and
generating, by an MILP solver engine, one or more solutions associated with dispatching and managing the set of workers in association with solving the MILP problem.
